(19) United States
(12) Patent Application Publication
(10) Pub. No.: US 2007/0150667 A1
(43) Pub. Date: Jun. 28, 2007

(54) Multiported memory with ports mapped to bank sets

(75) Inventors: Kuljit S. Bains, Olympia, WA (US); John B. Halbert, Beaverton, OR (US); Randy B. Osborne, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/317,757

(22) Filed: Dec. 23, 2005

(51) Int. Cl. G06F 13/28

(52) U.S. Cl. 711/149

(57) ABSTRACT

In some embodiments, a chip includes first and second bank sets, a first data port mapped to the first bank set, and a second data port mapped to the second bank set. Other embodiments are described.

### TECHNICAL FIELD

The present inventions relate to multiported memories in which different ports are mapped to different bank sets.

### BACKGROUND ART

Various arrangements for memory chips in a memory system have been proposed. For example, in a traditional synchronous dynamic random access memory (DRAM) system, memory chips communicate data through bidirectional data buses and receive commands and addresses through command and addresses buses. In some implementations, the memory chips have stubs that connect to the buses in a multi-drop configuration. Other designs include point-to-point signaling. Bidirectional signaling may be sequential or simultaneous.

A port is an interface to a chip and includes associated transmitters and/or receivers. A multi-ported memory has more than one data port. For example, in some implementations of a multi-port memory, one port may be used for only reading data while another port may be used for reading and writing data. For example, in a Video DRAM (VRAM) one port is used like a typical DRAM port and can be used for reading and writing. The second port is used only for reading.

Different ports may have a different width (number of conductors or lanes). The concept of having a variable interconnect width is known.

Memory modules include a substrate on which a number of memory chips are placed. The memory chips may be placed on only one side of the substrate or on both sides of the substrate. In some systems, a buffer is also placed on the substrate. For at least some signals, the buffer interfaces between the memory controller (or another buffer) and the memory chips on the module. In such a buffered system, the memory controller can use different signaling (for example, frequency and voltage values, and point-to-point versus a multi-drop arrangement) with the buffer than the buffer uses with the memory chips. A dual in-line memory module (DIMM) is an example of a memory module. Multiple modules may be in series and/or parallel. In some memory systems, a memory chip receives signals and repeats them to a next memory chip in a series of two or more memory chips.

Memory controllers have been used in chipset hubs and in a chip that includes a processor core.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIGS. 1 and 2 are each a block diagram representation of a system including a chip having a memory controller and a memory chip having data ports mapped to different bank sets according to some embodiments of the inventions.

FIG. 3 is a block diagram representation of a system including a chip having first and second data ports and a memory chip having data ports mapped to different bank sets according to some embodiments of the inventions.

FIG. 4 is a block diagram representation of a system including a chip having four unidirectional data ports and a memory chip having four unidirectional data ports according to some embodiments of the inventions.

FIGS. 5-7 are each a block diagram representation of a system including a chip having a memory controller and a memory chip having data ports mapped to different bank sets according to some embodiments of the inventions.

FIGS. 8-12 are each a block diagram representation of a system according to some embodiments of the inventions.

### DETAILED DESCRIPTION

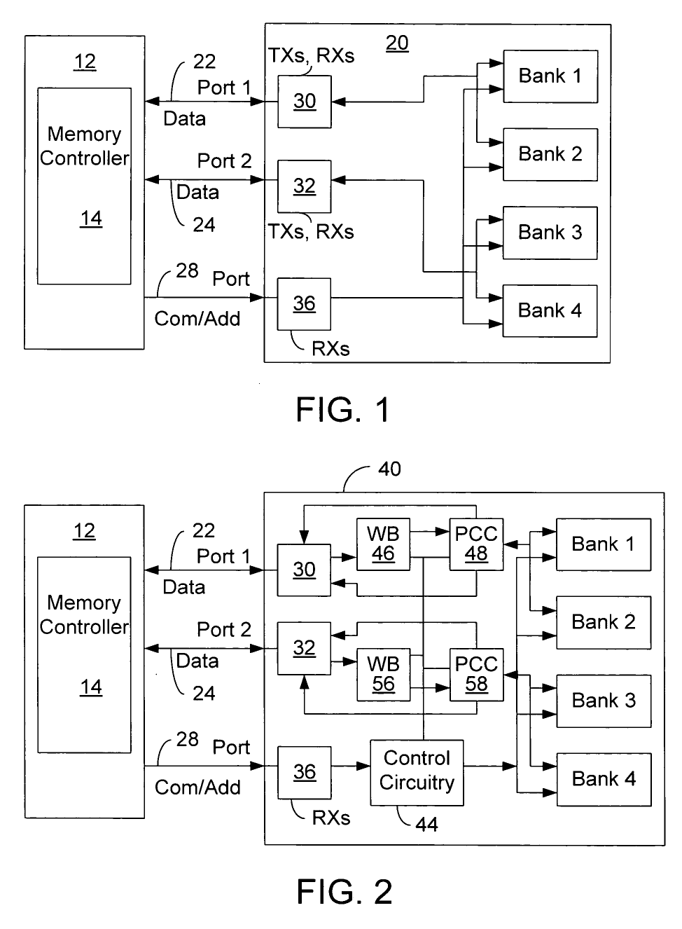

Referring to FIG. 1, a system includes a chip 12 and a memory chip 20. Chip 12 includes a memory controller 14. Data is communicated between chip 12 and memory chip 20 through interconnects, which is coupled to a bidirectional data port 1. Data is also communicated between chip 12 and memory chip 20 through interconnects 24, which is coupled to a bidirectional data port 2. Port 1 includes transmitters and receivers 30 and port 2 includes transmitters and receivers 32. Memory chip 20 may be a DRAM or other type of memory chip.

Port 1 is mapped to a first set of memory banks including a bank 1 and a bank 2 (collectively called the first bank set). Port 2 is mapped to a second set of memory banks including a bank 3 and a bank 4 (collectively called the second bank set). Write data from memory controller 14 are provided through port 1 to the banks 1 and 2, and read data from banks 1 and 2 are provided through port 1 to memory controller 14. (When it is said the data are provided to or from banks 1 and 2, it is noted that the data are not necessarily simultaneously provided to or from banks 1 and 2.) Likewise, write data from memory controller 14 are provided through port 2 to banks 3 and 4, and read data from banks 3 and 4 are provided through port 2 to memory controller 14. Data to or from banks 1 and 2 are not provided through port 2 and data to or from banks 3 and 4 are not provided through port 1. Although only two banks are illustrated for each bank set, the bank sets may include more than two banks each.

In some embodiments, reads and writes through port 1 may be independent of reads and writes through port 2, although in other embodiments, the reads and writes through ports 1 and 2 may be independent or in locked step.

Memory controller 14 provides command and address signals through interconnects 28 to a port including receivers 36. In some embodiments, each of banks 1-4 receive command and address signals from receivers 36.

In some embodiments, the inventions provide concurrent read and write accesses to the memory chip across each port. With proper command scheduling, a high effective bandwidth of the channel including the data ports can be achieved.

In an actual implementation of memory chip 20, there would be various circuitry between port 1 and banks 1 and 2 and between port 2 and banks 3 and 4. The nature of that circuitry varies depending on the embodiments involved. Some of the possibilities are illustrated in other figures. Still addition circuitry would be used in actual implementations.

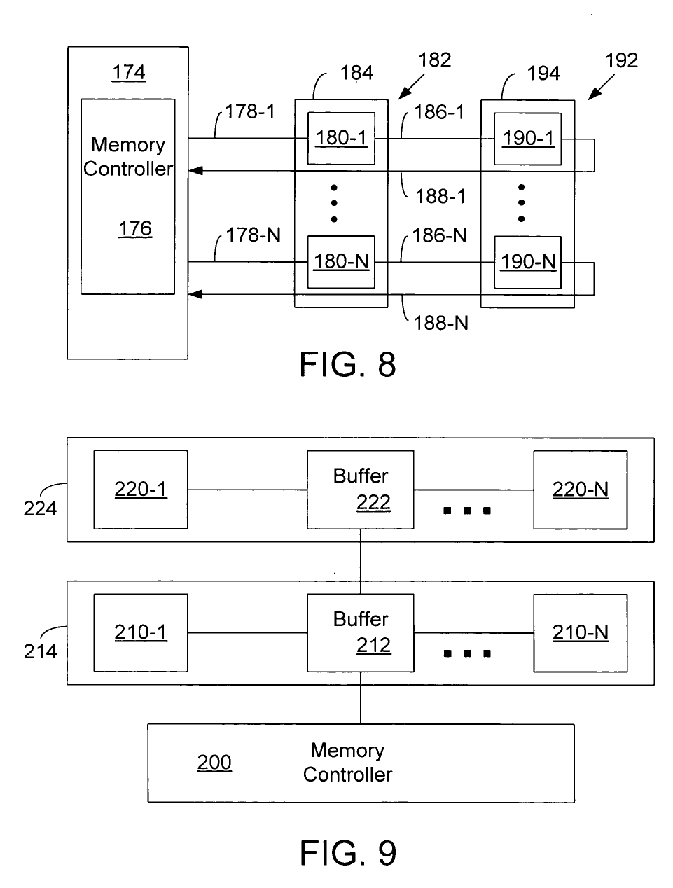

The system of FIG. 2 is similar to that of FIG. 1 except that some additional details are provided. Some embodiments of the inventions do not include these details. Referring to FIG. 2, a memory chip 40 includes a write buffer 46 which receives write data from port 1. Write buffer 46 may be used as follows. In some protocols, for a write request, the write data are first provided. A write command and address are thereafter provided. The write data stays in write buffer 46 until an associated command and address causes it to be written into bank 1 or 2 (and/or repeated to a next memory chip (see FIG. 8)). Some embodiments do not include write buffers or include write buffers that operate differently than described herein.

Still referring to FIG. 2, port control circuitry 48 receives the write data and passes it to banks 1 and 2. Port control circuitry 48 also receivers read data from bank 1 and 2 and provides it to port 1. Likewise, memory chip 40 includes a write buffer 56 which receives write data from port 2. Port control circuitry 58 receives the write data and passes it to banks 3 and 4. Port control circuitry 48 also receivers read data from bank 3 and 4 and provides it to port 2. Memory chip 40 further includes controller circuitry 44 that receives commands and addresses from receivers 36 and provides them to banks 1, 2, 3, and 4 (and/or repeats them to a next chip (see FIG. 8)). Control circuitry 44 also communicates with other circuitry.

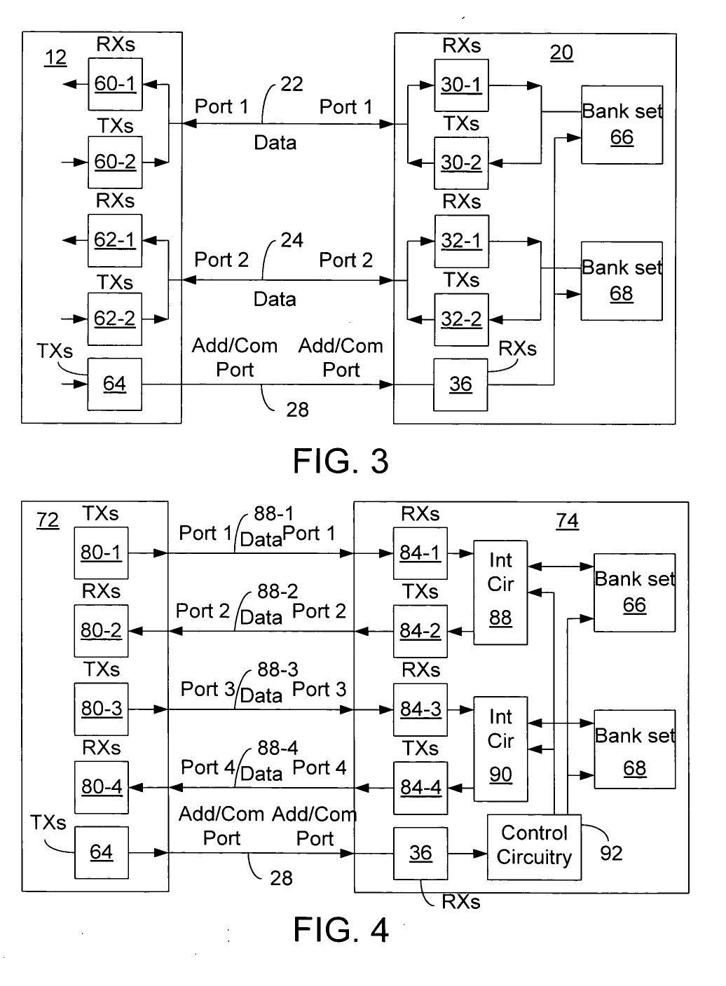

FIG. 3 illustrates receivers 30-1 and transmitters 30-2 of port 1, and receivers 32-1 and transmitters 32-2 of port 2. Bank set 66 is a first bank set and bank set 68 is second bank set. Bank sets 66 and 68 may each include one bank, two banks, or may include more than two banks. FIG. 3 also illustrates that chip 12 includes corresponding data ports 1 and 2. Port 1 of chip 12 includes receivers 60-1 and transmitters 60-2, and port 2 of chip 12 includes receivers 62-1 and transmitters 62-2. Transmitters 64 provide address and command signals through a port in chip 12, interconnect 28, and a port in chip 20 (including receivers 36). The transmitters and receivers may be considered part of the memory controller or separate from it.

FIG. 4 illustrates conductors with unidirectional signaling. By contrast, FIGS. 1-3 illustrate conductors with bidirectional signaling, which may be sequential or simultaneous. Referring to FIG. 4, a chip 72 (which includes a memory controller) includes data ports 1 and 3 which including transmitters 80-1 and transmitters 80-3, respectively, to transmit write data. Chip 72 also includes data ports 2 and 4 which include receivers 80-2 and receivers 80-4, respectively, to receive read data. Transmitters 64 provide address and command signals through a port in chip 12, interconnect 28, and a port in chip 74 (including receivers 36).

Memory chip 74 includes data ports 1 and 3 which include receivers 84-1 and receivers 84-3, respectively, to receive write data. Chip 74 also includes data ports 2 and 4 which include transmitters 84-2 and transmitters 84-4, respectively, to transmit read data from banks 66 and 68, respectively. Interface circuitry 88 interfaces between banks 66 and receivers 84-1 and transmitters 84-2. Interface circuitry 90 interfaces between banks 68 and receivers 84-3 and transmitters 84-4. Interface circuitry 88 and 90 may include a write buffer and control circuitry. Control circuitry 92 provides command and address signals to banks 66 and 68 and provides other control signals to interface circuitry 88 and 90.

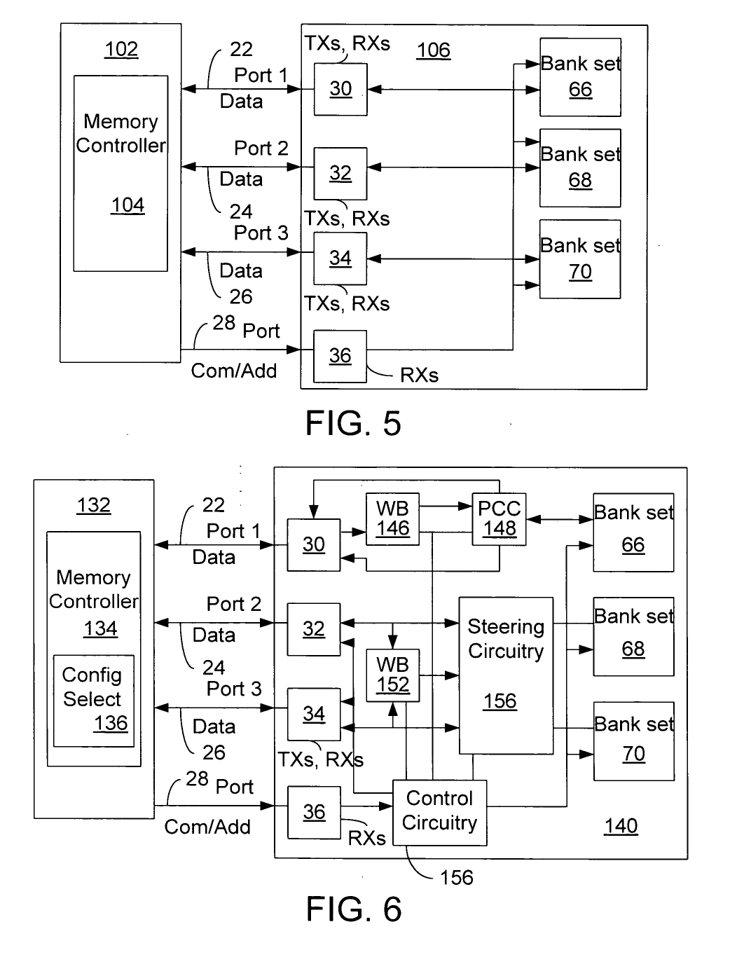

FIG. 5 illustrates a system with chip 102 including memory controller 104 and a memory chip 106 including bidirectional data ports 1, 2, and 3. Ports 1, 2, and 3 include transmitters and receivers 30, 32, and 34, respectively. Port 3 is coupled to interconnect 26. Ports 1, 2, and 3 are mapped to bank sets 66, 68, and 70, respectively. Commands and addresses are provided through receivers 36. In an actual implementation, there would be various circuitry between the ports and the bank sets.

FIG. 6 illustrates a system with a chip 132 and a memory chip 140. Chip 132 includes a memory controller 134, which includes configuration selection circuitry 136. Memory chip 140 includes three bidirectional data ports 1, 2, and 3, which include transmitters and receivers 30, 32, and 34, respectively. Port 1 is mapped to bank set 66 through write buffer 146 and port controller circuitry 148 (as in FIG. 2). However, ports 2 and 3 are coupled to bank sets 68 and 70 through steering circuitry 156. Steering circuitry 156 can direct read data from bank sets 68 and 70 to either or both of ports 2 and 3 or write data from ports 2 and 3 through write buffer 152 to either or both of bank sets 68 and 70. Configuration selection circuitry 136 chooses a configuration for the mapping of ports 2 and 3 with bank sets 68 and 70. That configuration is provided through interconnect 28, and a command/address port (which includes receivers 36) to control circuitry 156. Control circuitry 156 controls steering circuitry 156 and other circuits accordingly.

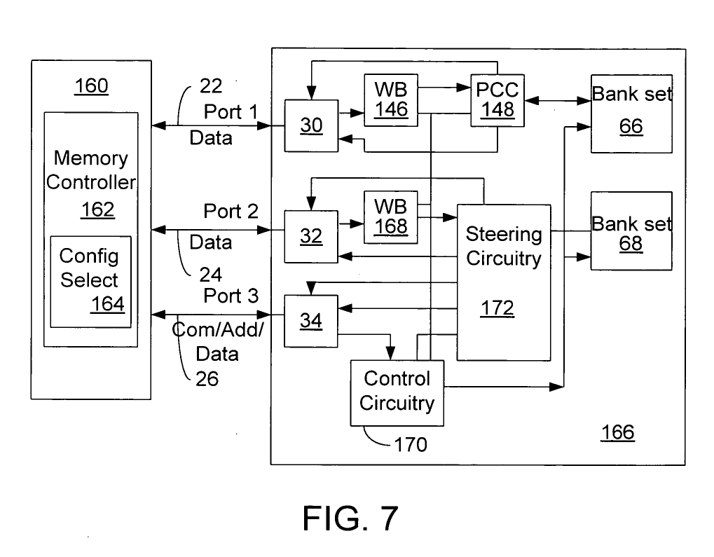

FIG. 7 illustrates a system with a chip 160 having a memory controller 162 and a memory chip 166. Memory chip 166 includes bidirectional ports 1, 2, and 3, which include transmitting and receiving circuitry 30, 32, and 34, respectively. Port 1 is mapped to bank set 66 through write buffer 146 and port controller circuitry 148 (as in FIGS. 2 and 6). Port 2 is mapped to bank set 68 through write buffer 148 and steering circuitry 172. Steering circuitry 172 directs read data from bank set 68 to port 2 and/or port 3. Control and address signals are provided through port 3 to controller circuitry 170. In some embodiments, at times, port 3 may also pass write data for bank set 68 and/or read data from bank set 68. Memory controller 162 may include configuration selection circuitry 164 to provide a command to control circuitry 170 to control steering circuitry 172 and associated circuitry.

The memory controllers and memory chips described herein may be included in a variety of systems. For example, referring to FIG. 8, chip 174, memory controller 176, and memory chips 180-1 . . . 180-N, and 190-1 . . . 190-N represent the various chips, memory controllers, and memory chips described herein. Conductors 178-1 . . . 178-N each represent one of more unidirectional or bidirectional interconnects described herein. As mentioned a memory chip, may repeat signals to a next memory chip. For example, memory chips 180-1 . . . 180-N repeat some signals to memory chips 190-N through interconnects 186-1 . . . 186-N. The signals may include command, address, and write data. The signals may also include read data. If read data is repeated from chips 180-1 . . . 180-N to chips 190-1 . . . 190-N, then the read data does not have to be sent directly to memory controller 176. In such a case, unidirectional signaling from memory controller 176 to chips 180-1 . . . 180-N may be used in the system of FIG. 8 rather than the bidirectional signaling of FIGS. 1-3 and 5-7. The read data can be sent from memory chips 190-1 . . . 190-N to memory controller 176 through interconnects 188-1 . . . 188-N. Interconnects 188-1 . . . 188-N are not included in all embodiments.

Still referring to FIG. 8, memory chips 180-1 . . . 180-N may be on one or both sides of a substrate 184 of a memory module 182. Memory chips 190-1 . . . 190-N may be on one or both sides of a substrate 194 of a memory module 192. Alternatively, memory chips 180-1 . . . 180-N may be on the motherboard that supports chip 174 and module 192. In this case, substrate 184 represents a portion of the motherboard. Where FIG. 8 or the other figures shows a single memory chip , there may be a chain of memory chips.

FIGS. 9 illustrates a system in which memory chips 210-1 . . . 210-N are on one or both sides of a memory module substrate 214 and memory chips 220-1 . . . 220-N are on one or both sides of a memory module substrate 224. In some embodiments, memory controller 200 and memory chips 210-1 . . . 210-N communicate through buffer 212, and memory controller 200 and memory chips 220-1 . . . 220-N communicate through buffers 212 and 222. In such a buffered system, the memory controller can use different signaling with the buffer than the buffer uses with the memory chips. These memory chips and memory controller 200 represent memory chips and memory controllers described herein. Some embodiments may include additional conductors not shown in FIG. 9.

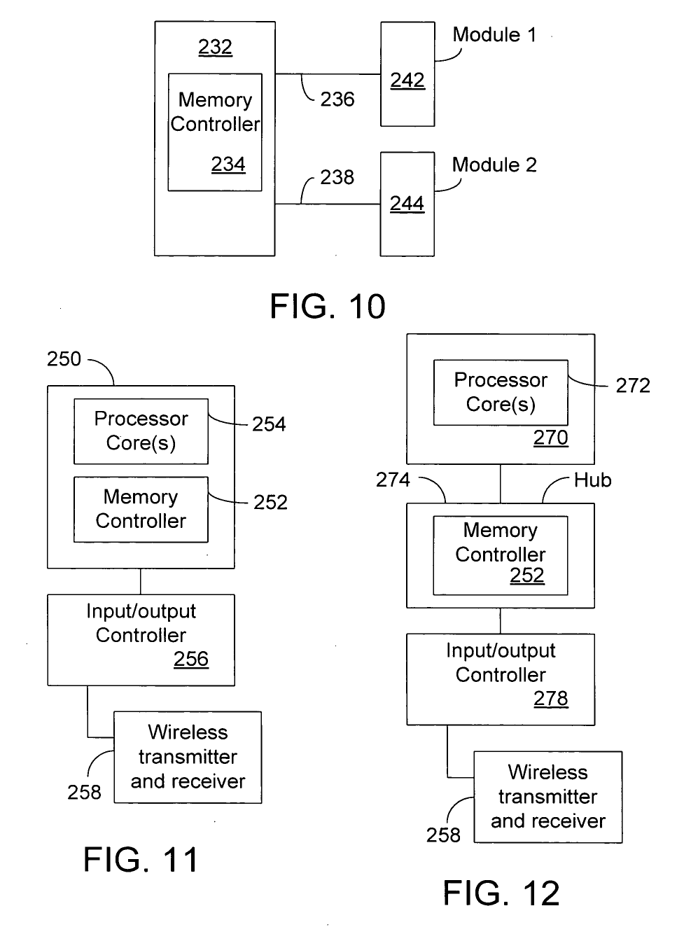

FIG. 10 illustrates first and second channels 236 and 238 coupled to a chip 232 including a memory controller 234. Channels 236 and 238 are coupled to memory modules 242 and 244, respectively, that include memory chips such as are described herein.

In FIG. 11, a memory controller 252 (which represents any of previously mentioned memory controllers) is included in a chip 250, which also includes one or more processor cores 254. An input/output controller chip 256 is coupled to chip 250 and is also coupled to a wireless transmitter circuitry and wireless receiver circuitry 258. In FIG. 13, memory controller 252 is included in a hub chip 274. Hub chip 274 is coupled between a chip 270 (which includes one or more processor cores 272) and an input/output controller chip 278. Input/output controller chip 278 is coupled to wireless transmitter circuitry and wireless receiver circuitry 258. If included, the configuration selection circuitry may be in the memory controller or elsewhere.

### ADDITIONAL INFORMATION AND EMBODIMENTS

Each of the interconnects illustrated and described may include multiple lanes, which may be one or two conductors each. The different interconnects may have the same or different widths.

The inventions are not restricted to any particular signaling techniques or protocols. For example, the signaling may be single ended or differential. The signaling may include only two voltage levels or more than two voltage levels. The signaling may be single data rate, double data rate, quad data rate, or octal data, etc. The signaling may involve encoded symbols and/or packetized signals. A clock (or strobe) signal may be transmitted separately from the signals or embedded in the signals. Various coding techniques may be used. The inventions are not restricted to a particular type of transmitters and receivers. Various clocking techniques could be used in the transmitters and receivers and other circuits. The receiver symbols in the figures may include both the initial receiving circuits and related latching and clocking circuits. The interconnects between chips each could be point-to-point or each could be in a multi-drop arrangement, or some could be point-to-point while others are a multi-drop arrangement.

In the figures showing one or more modules, there may be one or more additional modules in parallel and/or in series with the shown modules.

In actual implementations of the systems of the figures, there would be additional circuitry, control lines, and perhaps interconnects which are not illustrated. When the figures show two blocks connected through conductors, there may be intermediate circuitry that is not illustrated. The shape and relative sizes of the blocks is not intended to relate to actual shapes and relative sizes.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments.

When it is said the element “A” is coupled to element “B,” element A may be directly coupled to element B or be indirectly coupled through, for example, element C.

When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.”

If the specification states a component, feature, structure, process, or characteristic “may”, “might”, or “could” be included, that particular component, feature, structure, process, or characteristic is not required to be included. If the specification or claim refers to “a” or “an” element, that does not mean there is only one of the element.

The inventions are not restricted to the particular details described herein. Indeed, many other variations of the foregoing description and drawings may be made within the scope of the present inventions. Accordingly, it is the following claims including any amendments thereto that define the scope of the inventions.

What is claimed is:

1. A memory chip comprising:
first and second bank sets;
a first data port mapped to the first bank set; and
a second data port mapped to the second bank set.

2. The chip of claim 1, wherein the first and second data ports are bidirectional data ports.

3. The chip of claim 1, further comprising a unidirectional port to receive command and address signals and provide them to the first and second bank sets.

4. The chip of claim 1, further comprising a first write buffer coupled to the first port and a second write buffer coupled to the second port.

5. The chip of claim 4, further comprising first port control circuitry coupled between the first write buffer and the first bank set, and second port control circuitry coupled between the second write buffer and the second bank set.

6. The chip of claim 4, further comprising first port control circuitry coupled between the first port and the first bank set, and second port control circuitry coupled between the second port and the second bank set.

7. The chip of claim 6, further comprising a unidirectional port to receive command and address signals and control circuitry to receive the command signals, wherein the control circuitry provides control signals to the first and second port control circuitry.

8. The chip of claim 1, wherein there is concurrent read and write accesses to the first bank set through the first data port, and concurrent read and write accesses to the second bank set through the second data port.

9. The chip of claim 1, further comprising a third data port mapped to the third bank set, and the first, second, and third bank sets each include at least two banks.

10. The chip of claim 1, wherein the first and second data ports are unidirectional data ports and the chip further comprises a third data port mapped to the first bank set and a fourth data port mapped to the second bank set, wherein the third and fourth data sets are unidirectional ports.

11. The chip of claim 1, further comprising first interface circuitry coupled between the first and third data ports and the first bank set, and second interface circuitry coupled between the second and fourth data ports and the second bank set.

12. A memory chip comprising:
first and second bank sets;
a first data port mapped to the first bank set;
a second data port selectively mapped to the second bank set;
a combined command, address, and data port selectively mapped to the second bank set; and
steering circuitry to select the mapping between the second data port and the combined port and the second bank set.

13. The chip of claim 12, wherein the first and second data ports are bidirectional data ports.

14. The chip of claim 12, further comprising a first write buffer coupled to the first port and a second write buffer coupled to the second port.

15. The chip of claim 12, wherein there is concurrent read and write accesses to the first bank set through the first data port, and concurrent read and write accesses to the second bank set through the second data port.

16. A system comprising:
a first chip including a memory controller and first and second data ports and a command and address port;
a first, a second, and a third interconnect each including multiple lanes;
a second chip including:
first and second bank sets;
a first data port coupled to the first data port of the first chip and mapped to the first bank set; and
a second data port coupled to the second data port of the first chip and mapped to the second bank set.

17. The system of claim 16, wherein the first and second data ports of the second chip are bidirectional data ports.

18. The system of claim 16, further comprising a first write buffer coupled to the first port of the second chip and a second write buffer coupled to the second port of the second chip.

19. The system of claim 16, wherein there is concurrent read and write accesses to the first bank set through the first data port of the second chip, and concurrent read and write accesses to the second bank set through the second data port of the second chip.

20. The system of claim 16, wherein the first and second data ports of the first and second chips are unidirectional data ports.

21. The system of claim 20, further comprising third and fourth data ports for the first chip and third and fourth data ports for the second chip.

22. The system of claim 16, further comprising wireless transmitter and receiver circuitry coupled to the first chip.

23. The system of claim 16, wherein the first chip includes at least one processor core.
